(19) United States
(12) Patent Application Publication
(10) Pub. No.: US 2019/0130303 A1
(43) Pub. Date: May 2, 2019

(54) SMART DEFAULT THRESHOLD VALUES IN CONTINUOUS LEARNING

(71) Applicant: INTERNATIONAL BUSINESS MACHINES CORPORATION, ARMONK, NY (US)

(72) Inventors: RAFAL BIGAJ, KRAKOW (PL); LUKASZ G. CMIELOWSKI, KRAKOW (PL); WOJCIECH MIS, KRAKOW (PL); PAWEL SLOWIKOWSKI, KRAKOW (PL)

(21) Appl. No.: 15/794,216

(22) Filed: Oct. 26, 2017

(51) Int. Cl. G06N 99/00

(52) U.S. Cl. CPC G06N 99/005

(57) ABSTRACT

A method for improving a machine learning model may be provided. The method comprises
selecting a model quality metric of the machine learning model, determining a threshold value for a model quality value relating to the model quality metric using an X control chart method based on cross validation with a number of folds, equal to a number of possible model quality values, and on determining that the model quality value is below the determined threshold value, retraining the machine learning model with a new set of training data.

### BACKGROUND

The invention relates generally to a method for improving a machine learning model, and more specifically, to a method for an automatic continuous improvement of a machine learning model. The invention relates further to a system for improving a machine learning model and a computer program product.

Artificial intelligence as a general term for machine learning, deep learning and the like, has become very popular after similar technologies have been unsuccessful in finding real application areas in the last century. This was due to limited computational capacity and potentially too high expectations. Nowadays, new hardware architectures, as well as, an explosion in processor throughput made artificial intelligence one of the major growth areas of computer science. Many new application areas have been addressed recently.

Continuous machine learning introduces the idea of a regular evaluation of the machine learning model and a retraining based on feedback data. Thus, continues learning may represent a closed loop process for a continuous improvement in the ability for machines and algorithms getting better over time.

It's common to use different model evaluation methods to calculate metrics and based on the values determine if the underlying machine learning model is still performing well. The threshold values used by selected metrics may be helpful to determine when the model is considered to have low-quality and require re-training. Finding those correct threshold values is a non-trivial task that typically requires intensive data analysis and expert knowledge. So far, it is a manual, time-consuming and cumbersome task.

### SUMMARY

According to one aspect of the present invention, a method for improving a machine learning model may be provided. The method may comprise selecting a model quality metric of the machine learning model and determining a threshold value for a model quality value relating to the model quality metric using an X control chart method based on cross validation with a number of folds, equal to a number of possible model quality values.

The method may also comprise, on determining that the model quality value is below the determined threshold value, retraining the machine learning model with a new set of training data. Thereby, the machine learning model may be improved.

According to another aspect of the present invention, a system for improving a machine learning model may be provided. The system may comprise a selection unit adapted for selecting a model quality metric of the machine learning model and a determination unit adapted for determining a threshold value for a model quality value relating to the model quality metric. Thereby, the determination unit may be updated for using an X control chart method based on cross validation with a number of folds, equal to a number of possible model quality values.

The system may further comprise a retraining module adapted for, on determining that the model quality metric value is below the determined threshold value, retraining the machine learning model with a new set of training data. This way, the machine learning model may be improved.

Furthermore, embodiments may take the form of a related computer program product, accessible from a computer-usable or computer-readable medium providing program code for use, by or in connection with a computer or any instruction execution system. For the purpose of this description, a computer-usable or computer-readable medium may be any apparatus that may contain means for storing, communicating, propagating or transporting the program for use, by or in a connection with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above, and further aspects of the present invention, are apparent from the examples of embodiments to be described hereinafter and are explained with reference to the examples of embodiments, but to which the invention is not limited.

Preferred embodiments of the invention will be described, by way of example only, and with reference to the following drawings:

FIG. 1 shows a block diagram of an embodiment of the inventive method for improving a machine learning model.

FIG. 2 shows a block diagram of an embodiment of a more technically practical flowchart of the proposed method.

FIG. 3 shows a block diagram of another illustration of the decision process whether to trigger a retraining.

FIG. 4 shows a block diagram of an embodiment of the system for improving a machine learning model.

FIG. 5 shows an embodiment of a computing system comprising the system for improving a machine learning model.

### DETAILED DESCRIPTION

In the context of this description, the following conventions, terms and/or expressions may be used:

The term ‘machine learning’ may denote an application of artificial intelligence that automates analytical model building by using algorithms that iteratively learn from data without being explicitly programmed where to look. It constitutes a subfield of computer science that, according to Arthur Samuel, gives “computers the ability to learn without being explicitly programmed.” Evolved from the study of pattern recognition and computational learning theory in artificial intelligence, machine learning explores the study and construction of algorithms that can learn from, and make predictions on, data—such algorithms overcome following strictly static program instructions by making data-driven predictions or decisions, through building a model—in particular the machine learning model—from a plurality of sample inputs. Machine learning may be employed in a range of computing tasks where designing and programming explicit algorithms with good performance is difficult or infeasible.

The term ‘model quality metric’ may denote—in the mathematical sense—a distance function between rear, measured values and values generated out of a model comprising a plurality of parameters. The matrix may, e.g., be related to an accuracy of the method if compared to really measured values or to an error rate. Other model quality metrics may be possible.

The term ‘model quality value’ may denote an individually measured or experienced value. The value may relate to the model quality metric.

The term ‘X control chart method’—also known as Shewhart charts (after Walter A. Shewhart) or process-behavior charts, generally speaking may denote a statistical process control tool used to determine whether a process may be in a state of control. This may be translated to the here proposed method to “determine how good a machine learning model may anticipate the reality as measured”. The machine learning model may be an abstract mathematical model of a real situation, the model having a plurality of parameters that may be tuned in order to come closer to real measured values given a set of input variables.

The term ‘cross validation’—sometimes also called rotation estimation—may denote a model validation technique for assessing how the results of a statistical analysis on an independent data set may generalize. It is mainly used in settings where the goal is prediction, and one wants to estimate how accurately a predictive model—i.e., here, the machine learning mode—will perform in practice. In a prediction problem, a model is usually given a dataset of known data on which training is run (the training dataset), and a dataset of unknown data (or first seen data) against the model is tested (testing dataset). The goal of cross validation may be to define a dataset to “test” the model in the training phase (i.e., the validation dataset), in order to limit problems like overfitting, give an insight on how the model will generalize to an independent dataset (i.e., an unknown dataset, for instance from a real problem), etc.

One round of cross-validation involves partitioning a sample of data into complementary subsets, performing the analysis on one subset (called the training set), and validating the analysis on the other subset (called the validation set or testing set). To reduce variability, multiple rounds of cross-validation may be performed using different partitions, and the validation results are combined (e.g. averaged) over the rounds to estimate a final predictive model.

One of the main reasons for using cross-validation instead of using the conventional validation (e.g., partitioning the data set into two sets of about 70% for training and about 30% for evaluation/test) is that there may be not enough data available to partition it into separate training and test sets without losing significant modelling or testing capability. In those cases, a fair way to properly estimate model prediction performance may be to use cross-validation as a powerful general technique.

In summary, cross-validation combines (averages) measures of fit (prediction error) to derive a more accurate estimate of model prediction performance.

The term ‘original training data’ may denote a set of data used for an initial training of the machine learning model. After the machine learning model is trained, additional feedback data—i.e., real data—may be measured. The original training data and the measured feedback data may be combined to an enlarged training data set. This may be used for a retraining the machine model.

The proposed method for improving a machine learning model may offer multiple advantages and technical effects:

Basically, the decision about a retraining for machine learning model may be made completely autonomous. No human invention may be required for determining when a retraining of a machine learning model should be performed. The required threshold level(s) may constantly be evaluated based on real data from a machine learning production environment.

Advantageously, different model quality metrics may be used as part of the proposed method and system. Thus, a quality of the machine learning model may be evaluated under different aspects, i.e., on the different metrics. Depending on which metric the model quality assessment may be performed, the threshold value for a decision about a required retraining may be adjusted automatically and in line with an enlarged training data set, reflecting the original training data as well as the feedback data from the production system.

The included X control chart method may allow to partition the enlarged training data set into a plurality of folds—for example, three—wherein 70% to 80% of each fold may be used for a retraining and the remaining 20% to 30% of each fold may be used for an evaluation of the just retrained machine learning model. A combination of the results of the different forwards may allow determining an adapted adapted threshold value for a decision regarding a retraining of the machine learning model. Hence, the threshold value—which is one of the most important parameters for an autonomous machine learning process—for the retraining may be constantly adapted over time.

Based on the ever expanding enlarged data set, comprising the original training data and the feedback data, the knowledge base for enhancing the machine learning model may grow constantly so that the machine learning model improves itself—in particular in terms of an accuracy of the data model—continuously over time.

In the following, additional embodiments of the proposed method—also applicable for the related system—will be described:

According to one preferred embodiment, the method may also comprise collecting feedback data—in particular life data from a production environment instead of training data—and combining the feedback data with original training data of the machine learning model so that an enlarged training data set may be built, which may be equivalent to the new training data set. Hence, the knowledge base for an enhancement of the machine learning model grows constantly, laying continuously a better basis for the machine learning process.

According to one preferred embodiment, the method may also comprise determining the threshold value regularly or at predefined points in time. This may allow flexibility for the point in time, a retraining of the machine learning model may be performed. A retraining may be compute-intensive so that the retraining may be performed at an hour of comparably low usage of the computing system by production systems.

According to a permissive embodiment of the method, the number of folds may be 3. This may be a default value and other fold numbers may be possible. However, using 3 folds allow for a good average building and the number of feedback data sets per fold may be high enough to split between learning data (about 70% to 80% per fold) and confirming data (about 20% to 30% per fold).

According to a preferred embodiment, the method may also comprise building an average value aᵢ, i=1 . . . k, as part of the X control method, for each fold of the enlarged training data set, wherein k is the number of folds. Thus, the number of determined average values a, may equal the number of folds of the enlarged data set.

According to a further preferred embodiment, the method may also comprise determining an upper control limit (UCL) by UCL=ave+range * A2, wherein ave=Σaᵢ/k, range=max[aᵢ]−min[aᵢ], i=1 . . . k, and A2 may be a statistical constant for the X control method depending on the number of model quality values.

The so determined upper control limit may be used to realign the threshold value according to which a retraining of the machine learning model may be triggered. Therefore, and according to another preferred embodiment of the method, the determining the threshold value may comprise setting the threshold value to the upper control limit UCL if, e.g., the model quality metric may relate to a model correctness of the machine learning model. The same upper control limit may also be used for other model quality metrics.

According to an alternative embodiment, the method may also comprise determining a lower control limit (UCL) by LCL=ave−range * A2, wherein ave=Σaᵢ/k, range=max[aᵢ]−min[aᵢ], i=1 . . . k, and A2 may be a statistical constant for the X control method depending on the number of model quality values.

Also, this lower control limit may be used to realign the threshold value according to which a retraining of the machine learning model may be triggered. Therefore, and according to another preferred embodiment of the method, the determining the threshold value may comprise setting the threshold value to the lower control limit if, e.g., the more the quality metric relates to an error of the machine learning model. The same lower control limit may also be used for other model quality metrics.

According to an additionally advantageous embodiment of the method, the machine learning model may be selected out of the group comprising a classification model or algorithm—in particular support vector machine—or a regression method or algorithm—in particular linear regression.

In the following, a detailed description of the figures will be given. All instructions in the figures are schematic. Firstly, a block diagram of an embodiment of the inventive method for improving a machine learning model is given. Afterwards, further embodiments, as well as embodiments of the system for improving a machine learning model, will be described.

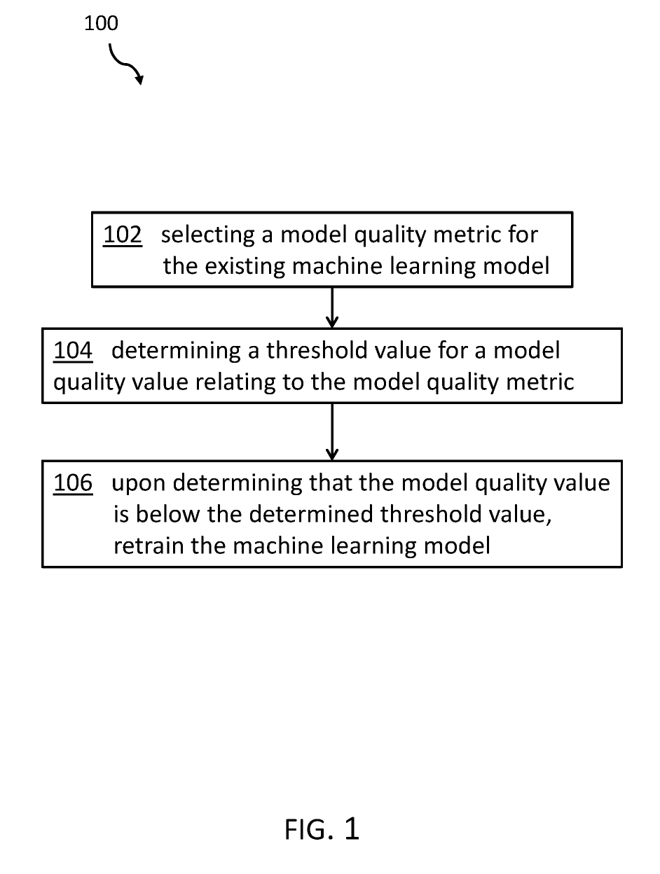

FIG. 1 shows a block diagram of an embodiment of the method 100 for improving a machine learning model. The method comprises selecting, 102, a model quality metric—i.e., a convention describing which model value may be used as quality measure, e.g., accuracy of the existing machine learning model. The resulting value may be normalized between 0 and 1 expressing the quality of the exiting trained model.

The method 100 comprises further determining, 104, a threshold value for a model quality value relating to the model quality metric using an X control chart method based on cross validation with a number of folds, equal to a number of possible model quality values.

Furthermore, the method 100 comprises, a retraining, 106, of the machine learning model with a new set of training data, if the model quality value is determined to be below the determined threshold value. The new set of training data may be feedback data of ongoing persisted data values from a production environment of the machine learning model or a combination of the original training data with the feedback data. Thereby, the machine learning model is continuously improved.

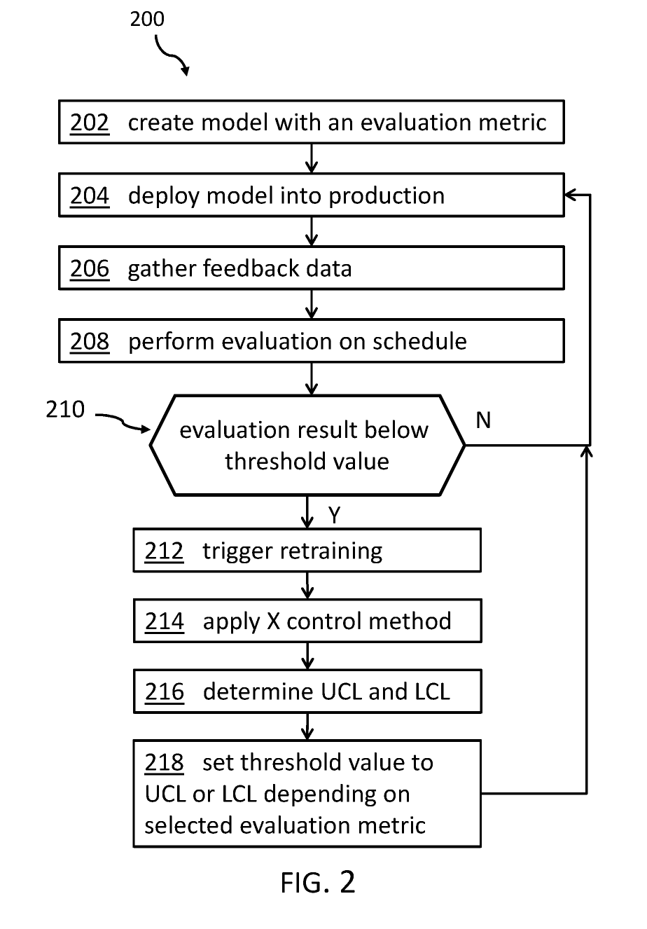

FIG. 2 shows a more technically practical flowchart 200 of the proposed method 100. Firstly, a machine learning model is created or selected, 202, by an expert and an evaluation metric—i.e., the model quality metric—is chosen. As an example, the accuracy of the machine learning model may be selected as evaluation metric. Using training data, the machine learning model is trained, 204, using training data. During this initial period, an operator also must select a threshold value for a decision about a retraining of the machine learning model.

In a next step, 206, the machine learning model is deployed into production and feedback data are gathered, 206. The gathered feedback data are then combined with the original training data building a larger group of training data, i.e., the enlarged training data set. It may also be possible to only use the gathered feedback data as enlarged training data set in leaving out the original training data. A determination which new training data set to be used may be performed automatically—e.g., based on the number of gathered feedback data—or by a manual process. If a predefined number of gathered feedback data may become available within a predefined period of time, an automatic determination may be performed to only use the gathered feedback data.

Based on this enlarged training data set a model evaluation is performed, 208, as scheduled—i.e., in regular time periods, after a predetermined amount of time or, after a predefined number of gathered feedback data has been collected.

If the evaluation result is above the originally defined threshold value—case “N” of detzerminatio 210—no retraining is triggered. However, if the evaluation result is below the originally defined threshold value—case “Y”—a retraining is triggered 212. The retraining is done using, 214, the k-fold cross-validation method, as explained above. Based on each fold, evaluation value X control charts are calculated, 216. The upper and lower control limits are then used for a smart threshold calculation to define, or set, 218, a new threshold value for a determination whether a retraining is required.

In case of the evaluation result is above the current threshold value, the process continues with the machine learning model in production together with additional feedback data. If, on the other side, a retraining was triggered, the process returns after step 218 (setting the new threshold value) to the step of deploying the machine learning model to production, 204. Also in this case, additional feedback data are gathered, 206.

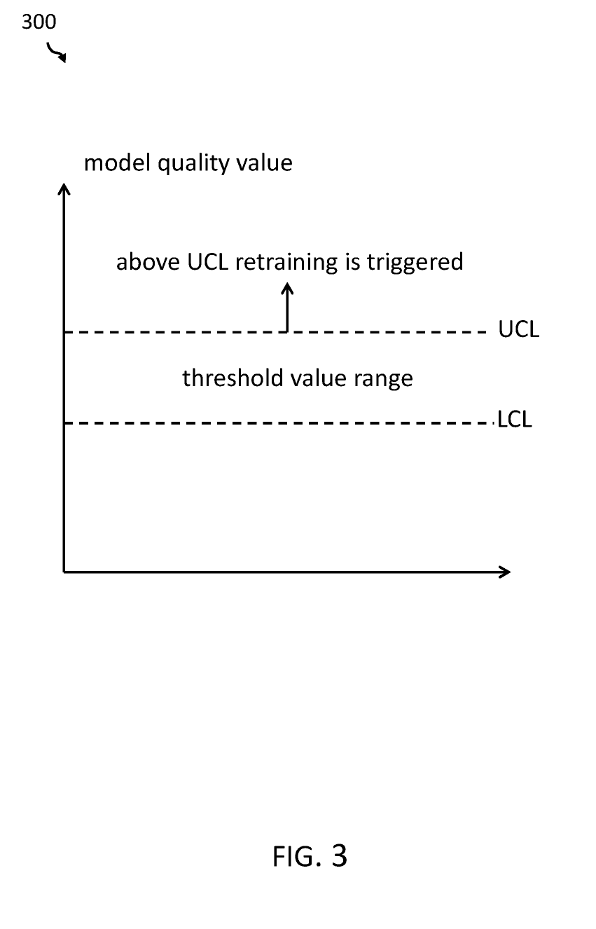

FIG. 3 is another illustration 300 of the decision process whether to trigger a retraining. Depending on the model quality metric selected, either the lower control limit or the upper control limit is used as a threshold value for a determination regarding a retraining of the machine learning model. On the vertical axis the model quality value is shown.

An example with real numbers may make the inventive concept a little more comprehensible. It may be assumed that the trained model is evaluated using a cross-validation with 3 fold. The related model quality metric values, e.g., foreign accuracy of the model may be 0.8, 0.85, 0.78. Based on those values upper and lower control limits may be calculated:

UCL=0.81+0.07×1.023=0.88;

LCL=0.81−0.07×1.023=0.73.

It should also be noted that the value of 0.1 is the mean value of the three average values of the folds. The value of the range of 0.07 is the maximum difference of the average values of the folds (i.e., 0.85−0.78 =0.07). The value of 1.023 may be extracted from standard tables known by a skilled person for the X control chart method.

Depending on the metric type, the threshold value is then set either to UCL or LCL: If the matrix is directed to an error, the threshold value is set to LCL; if—on the other side—the matrix is directed to a model correctness (i.e., accuracy) the threshold value is set to UCL. As explained above, the threshold value is then used as a trigger level for a model ultra-retraining. If a current model evaluation metric value is below the threshold value, a model retraining is triggered. Also, the newly trained model is evaluated and the loop starts all over again.

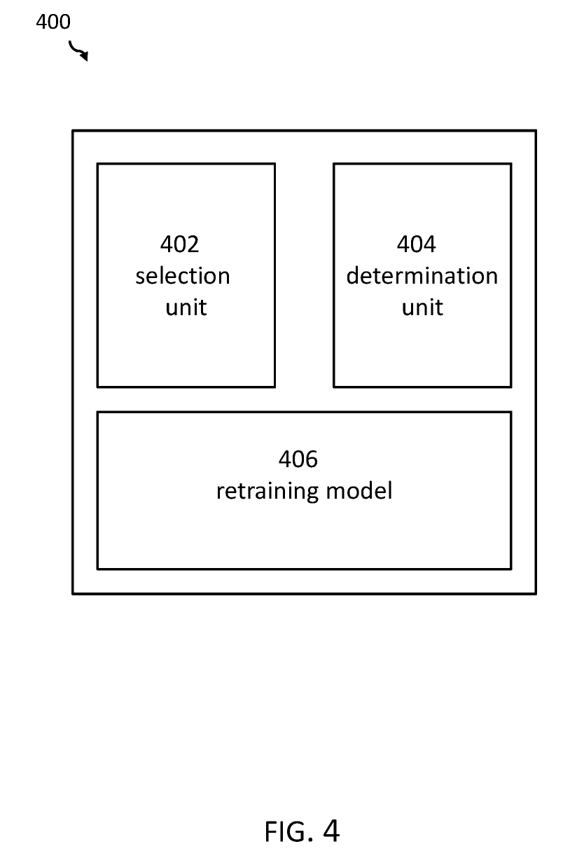

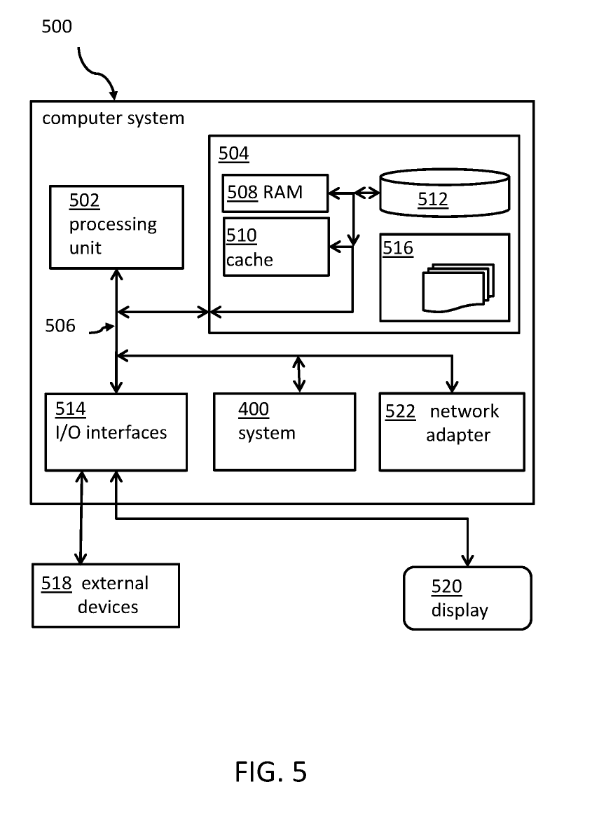

FIG. 4 shows a block diagram of an embodiment of the system 400 for improving a machine learning model. The system 400 comprises a selection unit 402 adapted for selecting a model quality metric of the machine learning model, a determination unit 404 adapted for determining a threshold value for a model quality value relating to the model quality metric. The determination unit is adapted for using an X control chart method based on cross validation with a number of folds, equal to a number of possible model quality values. The system 400 comprises additionally a retraining module 406 adapted for retraining the machine learning model with a new set of training data if the model quality metric value is determined to be below the determined threshold value. Thereby, a continuous learning process is enabled, and the quality of the machine learning model is consistently improved. Embodiments of the invention may be implemented together with virtually any type of computer, regardless of the platform being suitable for storing and/or executing program code. FIG. 5 shows, as an example, a computing system 500 suitable for executing program code related to the proposed method.

The computing system 500 is only one example of a suitable computer system and is not intended to suggest any limitation as to the scope of use or functionality of embodiments of the invention described herein. Regardless, computer system 500 is capable of being implemented and/or performing any of the functionality set forth hereinabove. In the computer system 500, there are components, which are operational with numerous other general purpose or special purpose computing system environments or configurations. Examples of well-known computing systems, environments, and/or configurations that may be suitable for use with computer system/server 500 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 500 may be described in the general context of computer system-executable instructions, such as program modules, being executed by a computer system 500. Generally, program modules may include routines, programs, objects, components, logic, data structures, and so on that perform particular tasks or implement particular abstract data types. Computer system/server 500 may be practiced in distributed cloud computing environments where tasks are performed by remote processing devices that are linked through a communications network. In a distributed cloud computing environment, program modules may be located in both local and remote computer system storage media including memory storage devices.

As shown in the figure, computer system/server 500 is shown in the form of a general-purpose computing device. The components of computer system/server 500 may include, but are not limited to, one or more processors or processing units 502, a system memory 504, and a bus 506 that couples various system components including system memory 504 to the processor 502. Bus 506 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 500 typically includes a variety of computer system readable media. Such media may be any available media that is accessible by computer system/server 500, and it includes both, volatile and non-volatile media, removable and non-removable media.

The system memory 504 may include computer system readable media in the form of volatile memory, such as random access memory (RAM) 508 and/or cache memory 510. Computer system/server 500 may further include other removable/non-removable, volatile/non-volatile computer system storage media. By way of example only, storage system 512 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 506 by one or more data media interfaces. As will be further depicted and described below, memory 504 may include at least one program product having a set (e.g., at least one) of program modules that are configured to carry out the functions of embodiments of the invention.

The program/utility, having a set (at least one) of program modules 516, may be stored in memory 504 by way of example, and not limitation, as well as an operating system, one or more application programs, other program modules, and program data. Each of the operating system, one or more application programs, other program modules, and program data or some combination thereof, may include an implementation of a networking environment. Program modules 516 generally carry out the functions and/or methodologies of embodiments of the invention as described herein.

The computer system/server 500 may also communicate with one or more external devices 518 such as a keyboard, a pointing device, a display 520, etc.; one or more devices that enable a user to interact with computer system/server 500; and/or any devices (e.g., network card, modem, etc.) that enable computer system/server 500 to communicate with one or more other computing devices. Such communication can occur via Input/Output (I/O) interfaces 514. Still yet, computer system/server 500 may communicate with one or more networks such as a local area network (LAN), a general wide area network (WAN), and/or a public network (e.g., the Internet) via network adapter 522. As depicted, network adapter 522 may communicate with the other components of computer system/server 500 via bus 506. It should be understood that although not shown, other hardware and/or software components could be used in conjunction with computer system/server 500. Examples, include, but are not limited to: microcode, device drivers, redundant processing units, external disk drive arrays, RAID systems, tape drives, and data archival storage systems, etc.

Additionally, the system 400 for improving a machine learning model may be attached to the bus system 506.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-RAY), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus', and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus', or another device to cause a series of operational steps to be performed on the computer, other programmable apparatus or other device to produce a computer implemented process, such that the instructions which execute on the computer, other programmable apparatus', or another device implement the functions/acts specified in the flowchart and/or block diagram block or blocks.

The flowcharts and/or block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A method for improving a machine learning model, said method comprising
selecting a model quality metric of said machine learning model,
determining a threshold value for a model quality value relating to said model quality metric using an X control chart method based on cross validation with a number of folds, equal to a number of possible model quality values, and
on determining that said model quality value is below said determined threshold value, retraining said machine learning model with a new set of training data, thereby improving said machine learning model.

2. The method according to claim 1, also comprising
collecting feedback data, and
combining said feedback data with original training data of said machine learning model building an enlarged training data set equivalent to said new training data set.

3. The method according to claim 1, also comprising determining said threshold value regularly or at predefined points in time.

4. The method according to claim 1, wherein said number of folds is 3.

5. The method according to claim 2, also comprising
building an average value aᵢ, i=1 . . . k, as part of said X control method, for each fold of said enlarged training data set, wherein k is said number of folds.

6. The method according to claim 5, also comprising
determining an upper control limit (UCL) by
UCL=ave+range * A2, wherein
ave=S ai/k,
range=max[aᵢ]−min[aᵢ], i=1 . . . k, and
A2 is a statistical constant for said X control method depending on said number of model quality values.

7. The method according to claim 6, wherein determining said threshold value comprises
setting said threshold value to UCL if said model quality metric relates to a model correctness of said machine learning model.

8. The method according to claim 5, also comprising
determining a lower control limit (UCL) by
LCL=ave−range * A2, wherein
ave=S ai/k,
range=max[aᵢ]−min[aᵢ], i=1 . . . k, and
A2 is a statistical constant for said X control method depending on said number of model quality values.

9. The method according to claim 8, wherein determining said threshold value comprises
setting said threshold value to LCL if said model quality metric relates to an error of machine learning model.

10. The method according to claim 8, wherein said machine learning model is selected out of a group comprising classification method and a regression method.

11. A system for improving a machine learning model, said system comprising
a selection unit adapted for selecting a model quality metric of said machine learning model,
a determination unit adapted for determining a threshold value for a model quality value relating to said model quality metric, wherein said determination unit is adapted for using an X control chart method based on cross validation with a number of folds, equal to a number of possible model quality values, and
a retraining module adapted for, on determining that said model quality metric value is below said determined threshold value, retraining said machine learning model with a new set of training data, whereby said machine learning model is improved.

12. The system according to claim 11, also comprising
collecting feedback data, and
combining said feedback data with original training data of said machine learning model building an enlarged training data set equivalent to said new training data set.

13. The system according to claim 11, wherein said determination unit is adapted for determining said threshold value for said model quality metric regularly.

14. The system according to claim 11, wherein said number of folds is 3.

15. The system according to claim 12, wherein said determination unit is also adapted for
building an average value aᵢ, i=1 . . . k, as part of said X control method, for each fold of said enlarged training data set, wherein k is said number of folds.

16. The system according to claim 15, wherein said determination unit is also adapted for
determining an upper control limit (UCL) by
UCL=ave+range * A2, wherein
ave=S ai/k,
range=max[aᵢ]−min[aᵢ], i=1 . . . k, and
A2 is a statistical constant for said X control method depending on said number of model quality values.

17. The system according to claim 16, wherein said determining unit is also adapted for
setting said threshold value to UCL if said model quality metric value relates to a model correctness of said machine learning model.

18. The system according to claim 15, wherein said determining unit is also adapted for
determining a lower control limit (UCL) by
LCL=ave−range * A2, wherein
ave=S aᵢ/k,
range=max[aᵢ]−min[aᵢ], i=1 . . . k, and
A2 is a statistical constant for said X control method depending on said number of model quality values.

19. The system according to claim 18, wherein said determining unit is also adapted for
setting said threshold value to LCL if said model quality value relates to an error of said machine learning model.

20. A computer program product for improving a machine learning model, said computer program product comprising a computer readable storage medium having program instructions embodied therewith, said program instructions being executable by one or more computing systems to cause the one or more computing systems to:
select a model quality metric of the machine learning model;
determine a threshold value for said model quality value relating to said model quality metric using an X control chart method based on cross validation with a number of folds, equal to a number of possible model quality metric values; and
on determining that said model quality value is below said determined threshold value, triggering a retraining of said machine learning model with a new set of training data, thereby improving the machine learning model.
